(19) United States
(12) Patent Application Publication
(10) Pub. No.: US 2006/0184924 A1
(43) Pub. Date: Aug. 17, 2006

(54) Intelligent platform management interface firmware architecture and method of building the same

(75) Inventor: Chih-tao Hsieh, Shijr City (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Aten International Co., Ltd.

(21) Appl. No.: 11/398,515

(22) Filed: Apr. 5, 2006

Related U.S. Application Data
(63) Continuation-in-part of application No. 10/905,059, filed on Dec. 14, 2004.

(51) Int. Cl. G06F 9/45; G06F 9/44

(52) U.S. Cl. 717/140; 717/162

(57) ABSTRACT

The present invention relates to an intelligent platform management interface (IPMI) firmware architecture and method for building the same, applied in an IPMI hardware architecture. The method comprises steps of selecting the hardware interface device; using the source code corresponding to the selected hardware interface device to define the environmental parameter of the IPMI hardware architecture; compiling the source code or further with the customized code to form the firmware object code; and linking the firmware object code to the core code pre-stored in the memory for constituting an image executing module for building the IPMI firmware architecture. The method further comprises a step of selectively modifying the customized code corresponding to the additional hardware interface device or to correct a compiling error according to the hardware interface device after the compiling step if the compiling error occurs, and returning to the compiling step, i.e. so called “a single step debugging process”.

### CROSS REFERENCE TO RELATED APPLICATION

This is a continuation-in-part of a U.S. patent application Ser. No. 10/905,059, filed on Dec. 14, 2004.

### FIELD OF THE INVENTION

The present invention relates to an intelligent platform management interface (IPMI) firmware architecture and method of building the same, and more particularly to an IPMI firmware architecture built in an IPMI hardware architecture, which is constituted by an image executing module involving at least one source code and at least one customized code for convenient revision.

### BACKGROUND OF THE INVENTION

As known in the art, when remote servers, such as telecommunication equipment or computer stations and especially ISP servers, are out of order, a system manager must go to the server's location to fix the breakdown. This requires a lot of manpower and time. To solve this issue, management technology for remote servers, such as the intelligent platform management interface (IPMI), has gradually been developed.

A typical IPMI system mainly comprises hardware architecture and firmware architecture. The hardware architecture is a piece of platform management hardware, usually a microcontroller with a built in baseboard management controller (BMC). On the other hand, the firmware architecture, which is embedding in the BMC, is actually a server management subsystem that works independently of the hardware of the server. In other words, the firmware architecture works independently from the central processing unit (CPU), the basic input/output system (BIOS), the operating system (OS) and the system management software (SMS) of the server. Particularly, while the CPU, BIOS and OS of the server are failing, the server management subsystem becomes the interface between the system management software and the platform management hardware.

However, according to the prior art, the method of building a customized IPMI firmware is first compiling a customized source code into customized binary code, and then linking the customized binary code to the main core binary code of the IPMI system, such the final customized IPMI product is developed. Wherein the main core binary code is a standard generalized IPMI control program to control the IPMI system, and the customized source code is another control program made by the IPMI system manufacturer to satisfy the user's hardware architecture according to the IPMI standard. Please refer to FIG. 1, which shows a flowchart with the steps of customizing the IPMI firmware according to the prior art. In Step 100, the IPMI system manufacturer first uses an application software interface to edit environmental parameters between the IPMI hardware architecture and the IPMI firmware architecture for generating a customized source code corresponding to the user's hardware architecture. In step 102, the IPMI system manufacturer compiles the customized source code to generate a customized binary code. Finally in step 104, the customized binary code and the main core binary code are combined in order to form the customized IPMI firmware.

As known in the prior art, the customized code must be translated into a transitional customized binary code first, and then integrate (linking, or combining) the customized binary code with the main core binary code. There are two disadvantages in such method. One is that because these binary codes are in the form of machine code, whenever an error is found, a user may have no idea how to check and debug the program for it is almost impossible for human beings to read the machine code. As a result, it is almost impossible for the user to modify the binary codes. The other is that the compiling process is more complicated. The step 102 for generating the customized binary code in order to link to the main core binary code is required according to the prior art. Meanwhile, because the source code corresponding to the hardware architecture has to be compiled into the form of binary code for linking with other binary codes, it therefore has to be predetermined corresponding to the hardware architecture and edited with the application software interface, i.e. once the hardware architecture the user using is changed, the source code also need to be modified accordingly, thus the user must ask the IPMI system manufacturer to develop a customized IPMI firmware according to the new hardware architecture.

Therefore, a method of customizing the IPMI firmware that simplifies the process of firmware compiling and solves the problem of difficult debugging, is required in the related industry.

### SUMMARY OF THE INVENTION

To overcome the drawbacks of the prior art, it is a primary objective of the present invention to provide an intelligent platform management interface (IPMI) firmware architecture involving at least one source code and one customized code, without the need of translating both of the codes into the form of binary code before compiling for convenient revision.

Another objective of the present invention is to provide a method of building an intelligent platform management interface (IPMI) firmware architecture which compiles the source code and the customized code to form a firmware object code, and then linking the firmware object code to the core code to constitute an image executing module, thereby simplifying the whole process of building the firmware architecture.

Another objective of the present invention is to provide a method of building an intelligent platform management interface (IPMI) firmware architecture, which is compatible with various kinds of hardware architecture with the use of open source code architecture.

According to the above objectives, the present invention provides a method of building an IPMI firmware architecture embedded in an IPMI hardware architecture. The method of building the IPMI firmware architecture is described below.

(a) Selecting at least one hardware interface device.

(b) Using the source code corresponding to the selected hardware interface device, to define at least one environmental parameter between the firmware architecture and the IPMI hardware architecture.

(c) Compiling the source code to form at least one firmware object code.

(d) Linking the firmware object code to at least one core code pre-stored in a memory area of the IPMI hardware architecture for building the IPMI firmware architecture.

According to the present invention, the intelligent platform management interface (IPMI) firmware architecture comprises an IPMI core subsystem and an image executing module. The image executing module is executed by the IPMI core subsystem for constituting the firmware architecture. The purpose of the IPMI core subsystem is to control the IPMI hardware architecture in corporate with the built firmware and the image executing module. Meanwhile, accompanying with at least one source code, at least one customized code may be compiled into the image executing module as the following description.

Each source code is a control program satisfying different types of hardware architecture, the source codes are made by the IPMI system manufacturer according to the IPMI standard. And each customized code is yet another control program satisfying further customization or special configurations of the user's hardware architecture, the customized code is made by the user, usually based the source codes provides by the IPMI system manufacturer. The customized code and source code are compiled to form the firmware object code. The core code, a standard generalized IPMI control program to control the IPMI system, stored in a program bank is linked with the preceding firmware object code to form the precedent image executing module. The program bank is commonly named by “library”, which is a standard program collection prepared for controlling IPMI hardware architecture. According to this invention, because the customized code may be modified according to the user's demand, if a compiling error is found, the user may also modify the customized code to fix the error, i.e. so called debugging. Because the source code and the customized code will be written in the same programming language, e.g. C language, the procedure of debugging can be a single step process in terms of compiling, modifying and re-compiling.

The merits of the present invention are: (a) the compiling process of the source code and the customized code is to compile both of the codes together to form a firmware object code instead of translating them into a binary code and a customized binary code respectively, therefore the debugging process can be done in a single step, (b) the process of building the firmware architecture is simplified as compiling the source code and the customized code to form a firmware object code, and then linking the firmware object code to the core code pre-stored in the program bank; (c) compatible with various hardware architecture without re-writing the source code because the open source code architecture is utilized such that the user may modify the customized code on their own.

These and other objectives of the present invention will no doubt become more obvious to those of ordinary skill in the art after reading the following detailed description of the preferred embodiment that is illustrated in the various figures and drawings.

### BRIEF DESCRIPTION OF THE DRAWINGS

The foregoing aspects and many of the attendant advantages of this invention will become more readily appreciated as the same becomes better understood by reference to the following detailed description when taken in conjunction with the accompanying drawings, wherein:

FIG. 1 is a flowchart that showing the steps of customizing the IPMI firmware according to the prior art.

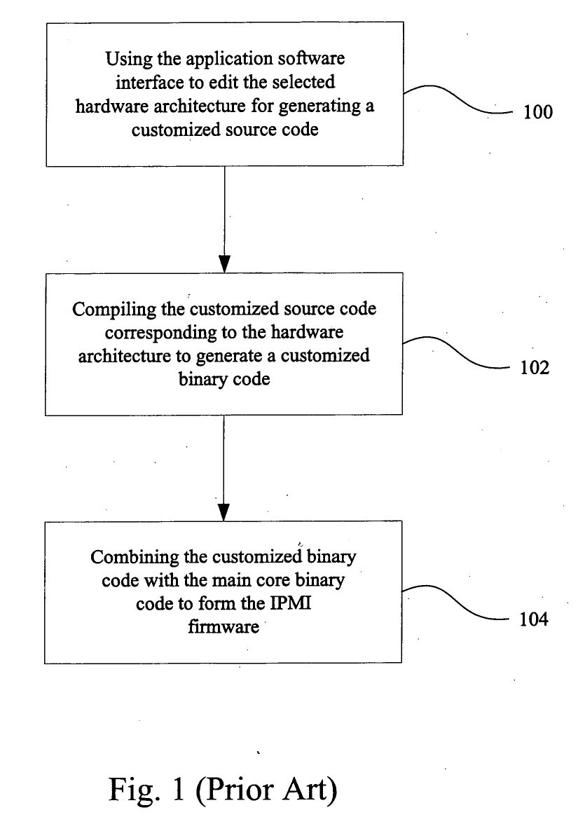

FIG. 2 is a functional block diagram of one embodiment of an intelligent platform management interface (IPMI) system architecture according to the present invention.

FIG. 3 is a diagram of one embodiment of forming an image executing module for building the IPMI firmware architecture according to the present invention.

FIG. 4 is a flowchart that showing the steps of customizing the IPMI firmware according to the embodiment shown in FIG. 2.

### DETAILED DESCRIPTION OF THE PREFERRED EMBODIMENTS

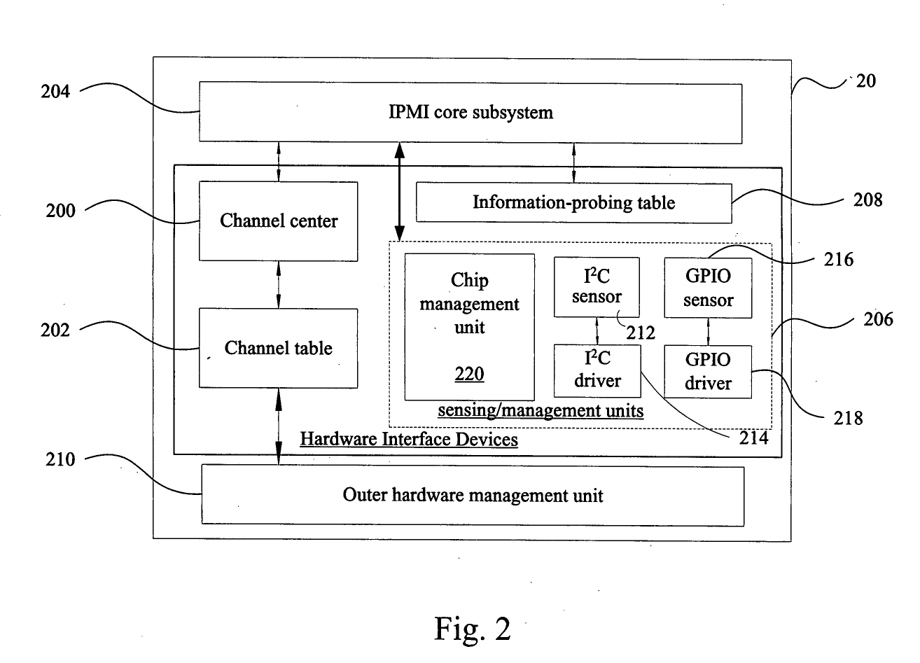

Firstly, refer to FIG. 2, one embodiment of an intelligent platform management interface (IPMI) system architecture 20 according to the present invention is shown. The architecture is suitable for IT management applications between a message source, such as a host system, and an operating terminal. The IPMI system architecture 20 in the present invention mainly comprises hardware interface devices such as a channel center 200, a channel table 202, a plurality of sensing/management units 206, and an information-probing table 208.

There is also a plurality of channel application interfaces (not shown in FIG. 2) in the channel center 200, such as IPMB or ICMB application interfaces. The channel center 200 uses a channel application interface to transmit or receive a channel message from the message source, and obtains an address pointer corresponding to the channel message. The channel table 202, which is coupled to the channel center 200, defines the channel application interface of the channel center 200 for updating the communication interface between the channel application interface and the outer hardware management unit 210. The channel table 202, such as a LAN/UART table, specifies the messages those pass through channel application interface. For example, a LAN/UART table may specify the messages those pass through the universal asynchronous receiver transmitter (UART) application interface and the local area network (LAN) application interface.

The IPMI core subsystem 204, which is coupled with the channel center 200, processes the channel messages. More particularly, the IPMI core subsystem 204 comprises a central message buffer unit, a message execution module and a memory control unit (not shown). The message execution module, which is coupled to the central message buffer unit, receives the address pointer corresponding to the channel message. The memory control unit, which is coupled to the message execution module, periodically inquires whether there is a newly sensed object in the memory of the sensing/management units 206 in order to obtain the information of the sensed object and store the obtained information.

The sensing/management units 206 coupling to the IPMI core subsystem 204 are used for sensing a physical change on a motherboard and storing the information of the sensed object in a memory. The information-probing table 208 coupling to the IPMI core subsystem 204 defines the sensing parameters between the sensing/management units 206 and the IPMI core subsystem 204, and controls the sensing of the sensing/management units 206 according to the message execution module. Each of the sensing/management units 206 according to the present invention, for example, could be an I²C sensor 212, an I²C driver 214, a GPIO sensor 216, a GPIO driver 218, and/or a chip management unit 220.

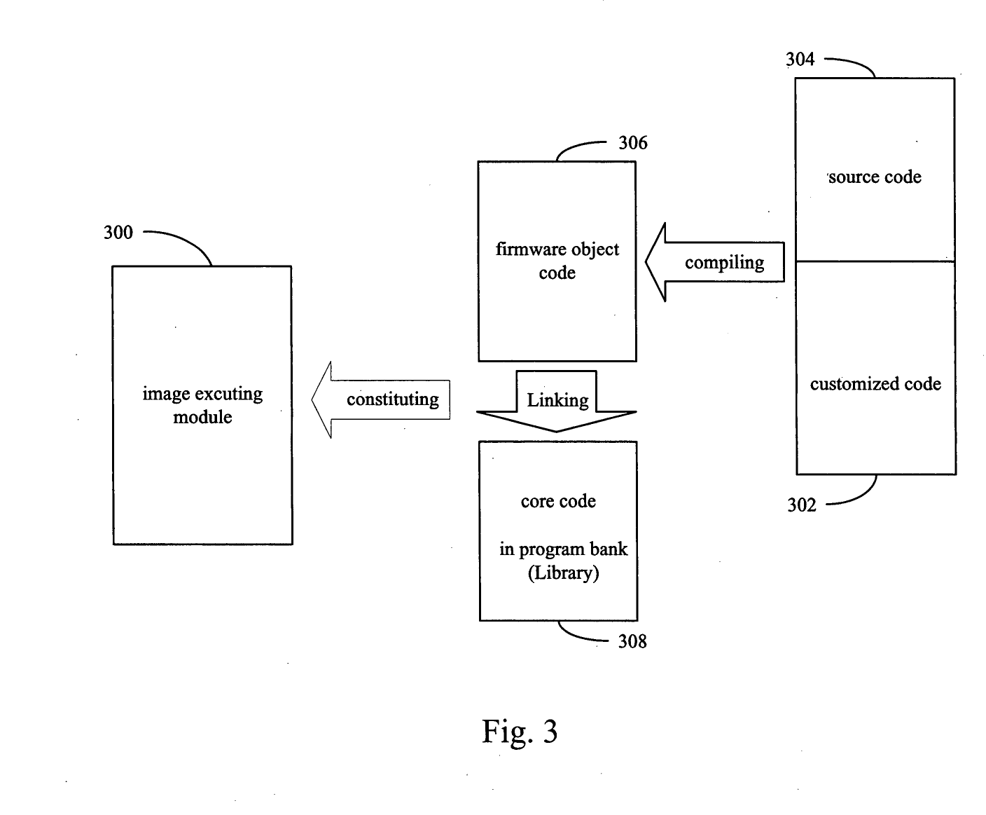

Please refer to FIG. 3, which is a diagram of one embodiment of forming an image executing module 300 for building the IPMI firmware architecture according to the present invention. The customized code 302 is written by the user in a kind of programming code to control the additional hardware interface device or to add some extra or specific function related with the specific hardware interface device. The customized code 302 defines the additional environmental parameters corresponding to the additional hardware interface device or the extra or specific function related to the specific hardware interface device of the IPMI hardware architecture. The source code 304 is written by the manufacturer in same kind of programming code of the customized code 302 to control the hardware interface devices with general functions of the basic IPMI hardware architecture.

The firmware object code 306 is the code in different language from the customized code 302 and the source code 304. The firmware object code 306 is formed by compiling the customized code 302 and the source code 304 together. It is noticed that even without the customized code 302, the pre-written source code (prepared by manufacturer) can still be compiled to form the basic firmware object code for the preceding basic IPMI hardware architecture. Practically, the customized code 302 does exist by default. Here we distinguish the firmware object code compiled from only the source code as “the basic firmware object code” from the one compiled with the customized code 302 and might also have been debugged as “the firmware object code 306”. The core code 308 (in program bank, also named Library) can be obtained from the IPMI specification defined by Intel, DELL, HP and NEC. The birth of IPMI specification is for controlling a large number and different kinds of servers fabricated by different manufacturers. Therefore, the core code 308 is standard program collection already established for controlling the basic IPMI hardware architecture. The core code 308 is prepared in the form of binary code for being linked by the preceding firmware object code 306. Linking the firmware object code 306 to the core code 308 is to constitute an image executing module 300. The image executing module 300 is an executable image file, which is a common form stored in a memory area, e.g. ROM to build the IPMI firmware architecture.

The image executing module 300 can be executed by the IPMI core subsystem 204 to build the IPMI firmware architecture. As aforementioned, the IPMI firmware architecture involves the image executing module 300, which is stored in a memory area as the firmware (not shown in Figures.), and the IPMI core subsystem 204. The customized code 302 and the source code 304 are compiled to form the firmware object code 306. A core code 308 pre-stored in the program bank (It is so called “Library”) is linked with the firmware object code 306 to form the image executing module 300. In one case for example, the user demands some additional or specific functions, controlling additional hardware interface devices or other different function over IPMI for instance, to the basic IPMI hardware architecture, and then writes a customized code 302 to get such benefits. The customized code 302 may include such as a hardware driver and a set of instructions for defining the proper additional environmental parameters in order to control the additional hardware interface devices or different functions over the IPMI, and such the extra or specific functions may be obtained. The customized code 302, just as the source code 304, is a kind of programming language, e.g. C or C++. It is noted that the basic IPMI firmware architecture can still operate functionally even without the customized code, but in that case, the extra or specific functions may not be operable. In the present invention, the source code 304 has already been preset according to the fundamental configuration of the IPMI hardware architecture, i.e. defining the environmental parameters between the firmware architecture and the IPMI hardware architecture and linked to the core code 308 to build the IPMI firmware architecture for controlling the IPMI hardware architecture. Although the pre-written source code can be used to form the basic firmware object code, every different server in the IPMI system may have a different hardware environmental setting. Thus the customized code 302 may be used to satisfy different hardware requirements or other add-on application requirements, for example, a fan temperature or fan rotating speed sensing/management unit. By compiling the source code 304 and the customized code 302 into a firmware object code 306 and linking the firmware object code 306 with the core code 308, the present invention can simplify each compiling, verification, and debugging processes for building the firmware architecture.

The core code 308 of the present invention could be in the form of the object code. The customized code 302 and the source code 304 may be written in C Languages (such as ANSI C or C+/C++) or other high-level or low-level programming languages and provides the user with the flexibility of actively adding extra or specific functions by writing a customized code 302 in C Languages. Furthermore, the IPMI firmware architecture according to the present invention may be compatible with various kinds of IPMI hardware architecture without the need of re-writing the source code because the open source code architecture is utilized such that the user may modify the customized code on their own.

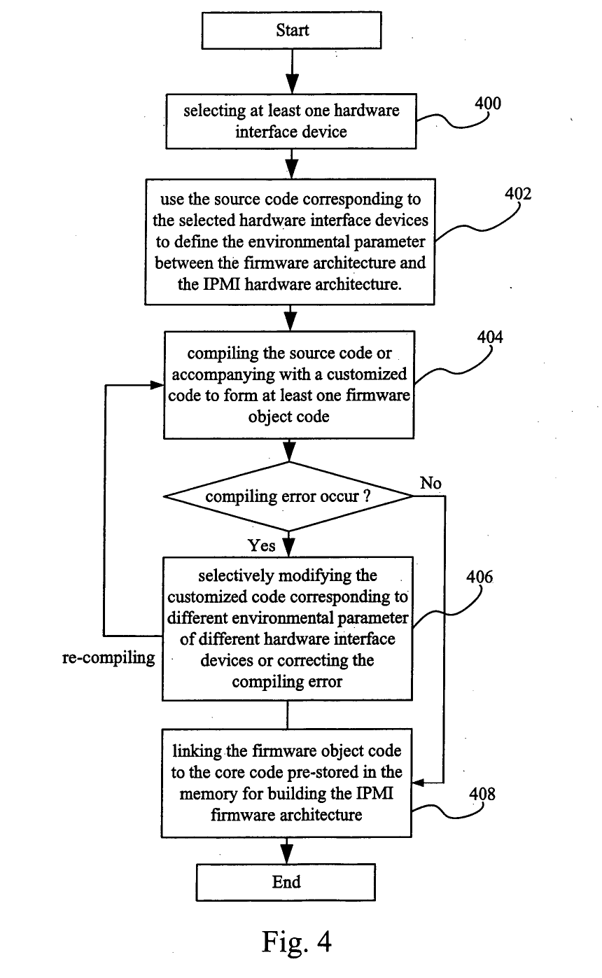

Please refer to FIG. 4, which shows a flowchart with the steps of customizing the IPMI firmware architecture according to the present invention, i.e. a method of building the IPMI firmware architecture, wherein the firmware is embedded in the IPMI hardware architecture in order to implement the IPMI system architecture.

In step 400, select at least one hardware interface device. The hardware interface device, for example, could be the channel center 200, the channel table 202, a plurality of sensing/management units 206, and/or the information-probing table 208 of the IPMI system architecture 20 shown in FIG. 2.

In step 402, use the source code 304 corresponding to the selected hardware interface devices to define at least one environmental parameter between the firmware architecture and the IPMI hardware architecture.

In step 404, compile the source code 304 or accompanying with a customized code to form at least one firmware object code 306.

After the step 404, if there is a compiling error, a debugging process could be executed as shown in step 406 which selectively modifying the customized code 302 corresponding to different environmental parameters of different hardware interface devices or correcting the compiling error, and then returning to step 404 for re-compiling. Otherwise, the procedure will directly get into next step 408. The compiling procedure of present invention is to compiling both of the customized code 302 and the source code 304 together to form a firmware object code 306, instead of translating them into a binary code and a customized binary code respectively and then composing them together.

In step 408, link the firmware object code 306 to at least one core code 308 pre-stored in the memory area of the IPMI hardware architecture for building the IPMI firmware architecture.

Moreover, the customized code 302 will be created in advance when the additional environmental parameters for additional hardware interface devices exist before the compiling step 404. The customized code 302 is also transmitted to the memory area of the IPMI hardware architecture after the creation and before the compiling step 404.

The advantages of the present invention are described as the following: (a) the compiling process of the source code 304 and the customized code 302 is to compile both of the codes together to form a firmware object code 306 instead of translating them into a binary code and a customized binary code respectively and them composing them together, thereby the debugging process can be done in a single step; (b) the process of building the firmware architecture may be simplified as compiling the customized code 302 and source code 304 into a firmware object code 306, and then linking the firmware object code 306 to the core code 308; (c) compatible with various kinds of IPMI hardware architecture without re-writing the source code 304 and the customized code because the open source code architecture is utilized.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of building an intelligent platform management interface (IPMI) firmware architecture embedded in an IPMI hardware architecture, wherein the IPMI hardware architecture comprises at least one hardware interface device, at least one source code and at least one core code pre-stored in a memory area, the method comprising steps of:
a. selecting the hardware interface device;
b. using the source code corresponding to the selected hardware interface device, to define at least one environmental parameter between the firmware architecture and the IPMI hardware architecture;
c. compiling the source code to form at least one firmware object code; and
d. linking the firmware object code to the core code for building the IPMI firmware architecture.

2. The method of claim 1, wherein after step b, further comprising:
b1. creating a customized code for defining at least one additional environmental parameter for an additional hardware interface device; and
wherein the customized code is compiled with the source code to form the firmware object code in step c.

3. The method of claim 2, wherein the customized code comprises at least one driver or one set of instructions.

4. The method of claim 2, wherein the customized code is modified based on the source code.

5. The method of claim 2, wherein after step b1, further comprising:
b2. transmitting the customized code to the memory area of the IPMI hardware architecture.

6. The method of claim 2, wherein the source code and the customized code are written in a same programming language.

7. The method of claim 6, wherein the source code and the customized code are written in C language.

8. The method of claim 2, wherein after step c, further comprising:
c1. if a compiling error occurs, selectively modifying the customized code to correct the compiling error and returning to step c.

9. The method of claim 1, wherein an image executing module is constituted for building the IPMI firmware architecture.

10. The method of claim 1, wherein the core code is a standard program collection prepared for controlling the IPMI hardware architecture.

11. A method of building an intelligent platform management interface (IPMI) firmware architecture embedded in an IPMI hardware architecture, wherein the IPMI hardware architecture comprises at least one hardware interface device, at least one source code, and at least one core code pre-stored in a memory area, the method comprising the steps of:
a. selecting at least one additional hardware interface device;
b. creating at least one customized code corresponding to the additional hardware interface device to define at least one additional environmental parameter;
c. using the customized code and the source code corresponding to the hardware interface devices to define the environmental parameters between the firmware architecture and the IPMI hardware architecture;
d. compiling the source code with the customized code to form at least one firmware object code; and
e. linking the firmware object code to the core code to constitute an image executing module for building the IPMI firmware architecture.

12. The method of claim 11, further comprising a step of transmitting the customized code to the memory area of the IPMI hardware architecture after step c.

13. The method of claim 11, wherein the image executing module is an executable image file executed by the IPMI core subsystem to build the IPMI firmware architecture.

14. The method of claim 11, wherein the source code and the customized code are written in a same programming language.

15. The method of claim 14, wherein the source code and the customized code are written in C language.

16. The method of claim 11, wherein after step d, further comprising:
d1. if a compiling error occurs, selectively modifying the customized code to fix the compiling error and returning to step d.

17. The method of claim 11, wherein the core code is a standard program collection prepared for controlling IPMI hardware architecture.

18. An intelligent platform management interface (IPMI) firmware architecture embedded in an IPMI hardware architecture of an IPMI system architecture, wherein the IPMI hardware architecture comprises at least one hardware interface device and a memory area, the IPMI firmware architecture comprising:
an IPMI core subsystem for controlling the IPMI hardware architecture; and
an image executing module, executed by the IPMI core subsystem, for building the IPMI firmware architecture, wherein the image executing module is constituted by linking at least one firmware object code corresponding to the hardware interface device, for defining at least one environmental parameter between the firmware architecture and the IPMI hardware architecture, with at least one core code pre-stored in the memory area of the IPMI hardware architecture for being a standard program collection prepared for controlling the IPMI hardware architecture.

19. The IPMI firmware architecture of claim 18, wherein the firmware object code is compiled from at least one source code defining at least one environmental parameter between the firmware architecture and the IPMI hardware architecture.

20. The IPMI firmware architecture of claim 19, wherein the firmware object code is further compiled from the source code accompanying with at least one customized code, defining at least one additional environmental parameter between the firmware architecture and the IPMI hardware architecture for an additional hardware interface device.
